(19) United States
(12) Patent Application Publication
(10) Pub. No.: US 2018/0150808 A1
(43) Pub. Date: May 31, 2018

(54) CANONICAL DATA STRUCTURE MAPPING

(71) Applicant: Bank of America Corporation, Charlotte, NC (US)

(72) Inventors: David Anthony Haley, Chelmsford (GB); Christopher Hope, Tonbridge (GB); Savit A. Pirl, Bolingbrook, IL (US); Alex Y. Yang, Woodinville, WA (US); David S. Shores, Lincoln, RI (US); Robert Laurentius Andela, London (GB); Jian Chen, Charlotte, NC (US); Satish Narayan, Charlotte, NC (US); Gurpreet Pahwa, Charlotte, NC (US); Colin S. Kerr, Chicago, IL (US)

(21) Appl. No.: 15/362,248

(22) Filed: Nov. 28, 2016

(51) Int. Cl. G06Q 20/10; G06F 17/30

(52) U.S. Cl. CPC G06Q 20/10; G06F 17/30569

(57) ABSTRACT

Method and apparatus for transforming data structures into canonical data structures are provided. The methods may include receiving data structures in specific formats and receiving data structures in exceptional formats. The method may include determining the type of format of each of the received data structures. The method may include creating a map for each of the received data structures. The method may include transforming each of the received data structures into a canonical data structure based on the created map. An exceptional data structure map may include a map used for another specific data structure with an overlay of the information exceptional to the exceptional data structure.

### FIELD OF TECHNOLOGY

This invention relates to data structures. More specifically, this invention relates to mapping of data structures.

### BACKGROUND OF THE DISCLOSURE

Data structures are typically received at various entities along a data path. For each entity, each data structure may require transformation into a different format. In addition, each data structure may also require transmission to an end entity.

Conventionally, many of the various entities along the data path may transform each of the data structures. Also, many of the various entities transmit the data structures to other entities. Many times, a data structure experiences a number of transformations and a number of entity-shifts prior to being transmitted to its end destination.

Transforming one data structure numerous times to accommodate numerous entities along a data path may be inefficient. Also, transmitting a data structure from entity to entity prior to being transmitted to the end entity wastes time and resources.

Therefore, it is desirable for a data structure system that receives all data structures at one data structure center. It is also desirable for a data structure system that transforms all the received data structures into one canonical data structure format at the data structure center. It is further desirable that the data structure center transmits the transformed data structures to each of their respective end destinations.

### SUMMARY OF THE DISCLOSURE

Methods and apparatus for transforming a data structure in a specific format into a data structure in a canonical format are provided. The method may include receiving a plurality of specific data structure formats. Each data structure format may designate a plurality of component parts in a predetermined order.

The method may include defining a base map for each specific data structure format. The base map may define a plurality of specific locations. The specific locations may be configured for retrieving a predetermined set of data.

The method may include receiving a plurality of exceptional data structure formats. Each of the plurality of exceptional formats may be associated with a specific data structure format. Each exceptional format may designate an order of component parts. The designated order of component parts may be a partially different order from a designated order of component parts of a specific format. The specific format may be the format with which the exceptional format is an exception thereto.

The method may include defining a custom map. A custom map may be defined for each exceptional format. The custom map may include a portion of the base map. The included portion may be associated with the component parts which are in the partially different order.

The method may include overlaying the custom map on the associated base map. Overlaying the custom map on the base map may create a normalized map for each exceptional format.

The method may include receiving a data structure. The method may also include determining the format of the received data structure. The method may also include determining whether the format of the data structure is a non-exceptional format or an exceptional format.

The method may also include selecting a map. The map selection may be based on the format of the received data structure. The map selection may also be based on the determining whether the format is a non-exceptional format or an exceptional format.

The method may also include transforming the received data structure into a canonical data structure utilizing the selected map. The transforming may include retrieving a predetermined number of data segments from locations determined by the selected map. The transforming may also include placing the data segments into the canonical data structure based on a canonical terms catalog.

In some embodiments, the received data structure may be a payment data structure. In other embodiments, the received data structure may be a payment structure.

In certain embodiments, the method may include receiving a second data structure. The method may include determining the format of the second data structure. The method may also include determining whether the format of the second data structure is a non-exceptional format or an exceptional format. The method may also include selecting a second map. The selection of the second map may be based on the format of the second data structure. The selection of the second map may be based on the determining whether the format of the second data structure is a non-exceptional format or an exceptional format. The method may also include transforming the second data structure into a second canonical data structure utilizing the second selected map.

It should be appreciated, that the method is not limited to any number of data structures. It should further be appreciated that the method may process many trillions of data structures or one or two data structures or any number in between.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art illustrative architecture diagram;

FIG. 2 shows an illustrative architecture diagram in accordance with principles of the invention;

FIG. 3 shows an illustrative flow diagram in accordance with principles of the invention;

FIG. 4 shows another illustrative flow diagram in accordance with principles of the invention;

FIG. 5 shows yet another illustrative flow diagram in accordance with principles of the invention;

FIG. 6 shows an illustrative source file format in accordance with principles of the invention;

FIG. 7 shows another illustrative source file format in accordance with principles of the invention;

FIG. 8 shows yet another illustrative source file format in accordance with principles of the invention;

FIG. 9 shows still another source file format in accordance with principles of the invention;

FIG. 10 shows illustrative map examples in accordance with principles of the invention;

FIG. 11 shows an illustrative map merge and/or override example in accordance with principles of the invention;

FIG. 12 shows an illustrative flow chart in accordance with principles of the invention;

FIG. 13 shows an illustrative graphical user interface (“GUI”) in accordance with principles of the invention;

FIG. 14 shows another illustrative GUI in accordance with principles of the invention;

FIG. 15 shows yet another illustrative GUI in accordance with principles of the invention;

FIG. 16 shows still another illustrative GUI in accordance with principles of the invention;

FIG. 17 shows yet another illustrative GUI in accordance with principles of the invention; and

FIG. 18 shows still another illustrative GUI in accordance with principles of the invention.

### DETAILED DESCRIPTION OF THE DISCLOSURE

Methods and apparatus for transforming a data structure in a specific format into a data structure in a canonical data format is provided. The apparatus may include a receiver. The receiver may be configured to receive a plurality of specific data structure formats. Each specific data structure format may designate a plurality of component parts in a predetermined order.

In should be appreciated that, is some embodiments, the apparatus may receive a plurality of data structures. Each of the data structures may be formatted in one of a plurality of various formats. Upon receipt of a data structure, the apparatus may deduce or construct a format based on the received data structure. It may store the format for comparing to other data structures in the future.

The receiver may also be configured to receive a plurality of exceptional data structure formats. Each of the plurality of exceptional formats may be associated with a specific data structure format. Each exceptional format may designate an order of component parts. The order of components parts may be partially different from the order of component parts of a specific format. The specific format may be the specific format with which the exceptional format is an exception thereto.

It should be appreciated that, in some embodiments, the apparatus may receive a plurality of data structures. Some of the received data structures may be formatted in specific data structure formats. Some of the received data structures may be formatted in exceptional data structure formats. An exceptional data structure format may be similar to one specific data structure format. There may be some differences between the exceptional data structure format and the associated specific data structure format.

For example, a fictional specific data structure format named—“ABC”—may include a data segment A on the third line, data segment B on the eighth line and data segment C on the tenth line. A fictional exceptional data structure format named—“ABCCC”—may be associated with, and a variant of, having the same components as specific data structure format—“ABC.” Exceptional data structure format—“ABCCC”—may include data segment A on the fourth line, data segment B on the eighth line and data segment C on the tenth line.

The apparatus may also include a processor. The processor may be configured to define a base map for each specific data structure format. The base map may define a plurality of specific locations for retrieving a predetermined set of data. The base map may also include directions and instructions for retrieving the predetermined set of data.

The processor may also be configured to define at least one custom map for each exceptional format. The custom map may include only a portion of the base map. The custom map may include a portion of the base map. The portion of the base map may be associated with component parts which are in the partially different order, see segment A discussed in paragraph 0038.

In yet another example, a base map may specify to skip fifteen commas on the third line in order to locate data segment D.

The processor may also be configured to overlay a custom map on its associated base map. The overlaying may create a normalized map for each exceptional format.

The receiver may be further configured to receive a data structure. The receiver may also be configured to receive a plurality of data structures. The receiver may also be configured to receive batches of data structures.

The processor may be further configured to determine the format of the received data structure or data structures. The processor may also be configured to determine whether the format of the data structure is a non-exceptional format or an exceptional format.

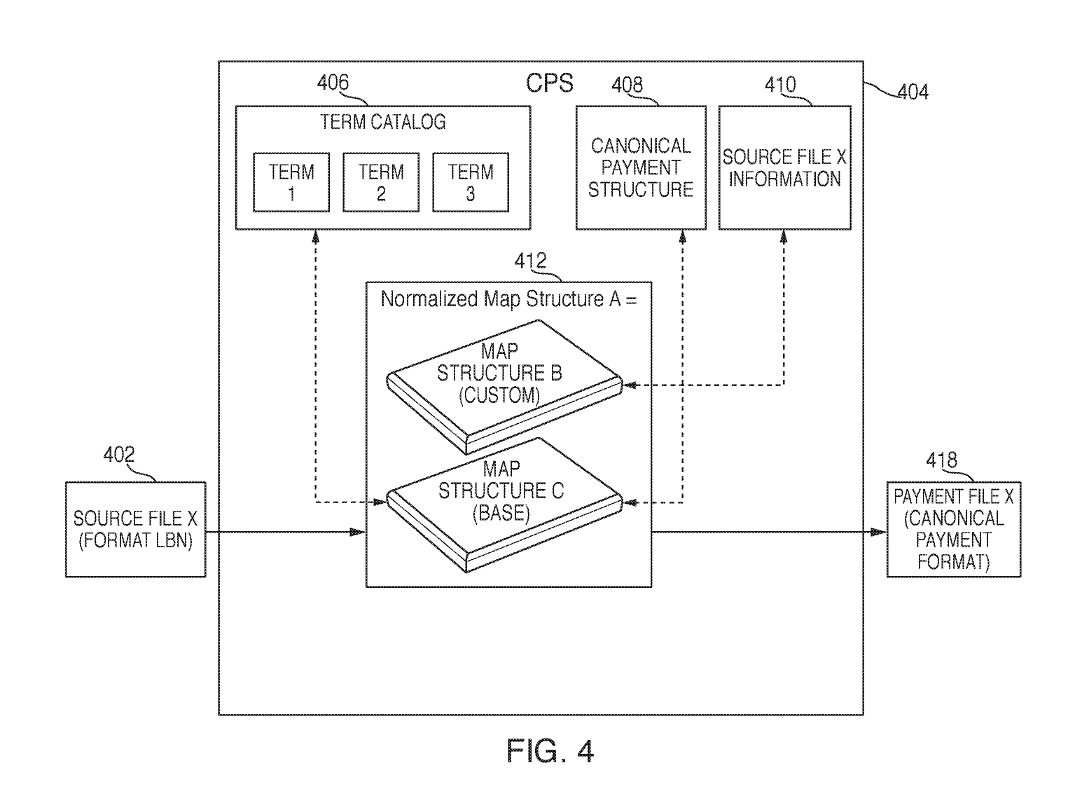

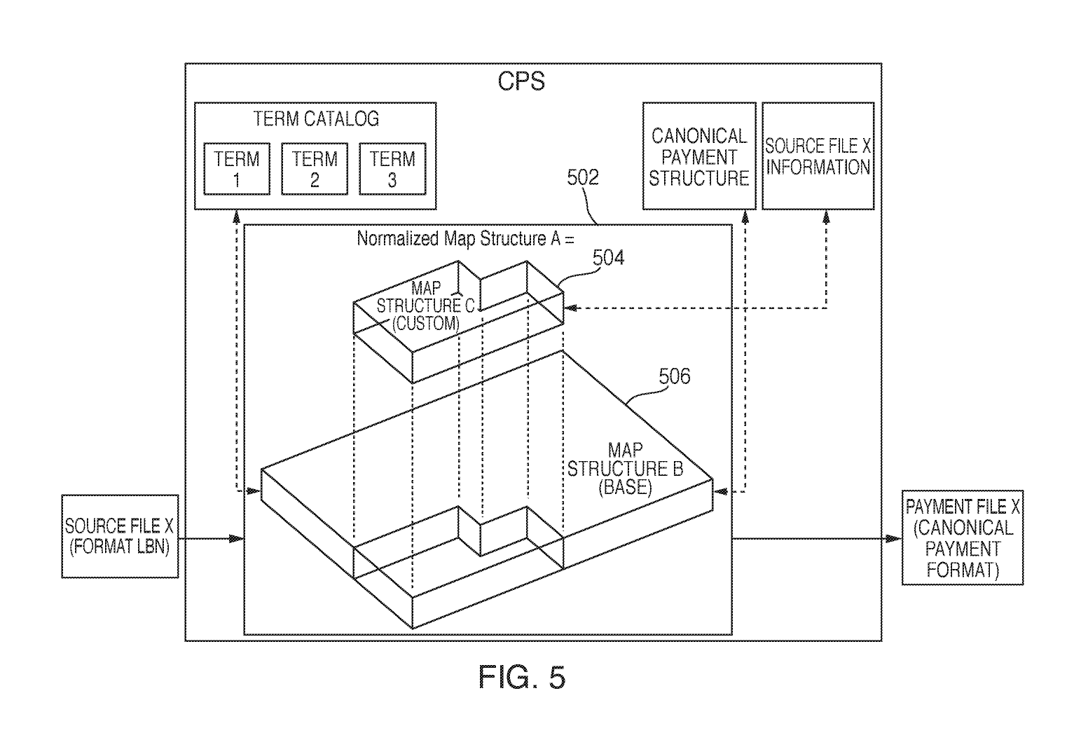

The processor may be configured to select a map. The selection may be based on the format of the received data structure. To the extent the received data structure corresponds with a based map, the processor may select a base map; to the extent that the received a data structure requires a custom map, the processor may select a normalized map, as described in more detail below in connection with the portion of the specification corresponding to FIGS. 4-5. The selection may also be based on the determination whether the format is a non-exceptional format or an exceptional format. In embodiments where there is more than one received data structure, the processor may be configured to select a map for each received data structure.

The processor may also be configured to transform the received data structure into a canonical data structure utilizing the selected map. The transformation may include retrieving a predetermined number of data segments from locations determined by the selected map. The transformation may also include placing the data segments into the canonical data structure based on a canonical terms catalog.

In some embodiments, the received data structure may be a payment data structure. In some embodiments, the received data structure may be a payment structure.

The file format of the received data structure may be eXtensible Markup Language (XML). The file format of the received data structure may be delimited. The file format may be delimited using a number of different delimiters, for example, comma, white space, hyphen, tab or any other suitable delimiters. The file format may also be positional. The file format may also be Society for Worldwide Interbank Financial Telecommunications (SWIFT). The file format may also be International Organization for Standardization (ISO). The file format may also be National Automated Clearing House Association (NACHA). The file format may also be Accredited Standards Committee x12. The file format may also be Electronic Data Interchange x12. The file format may also be Computer Readable Format (CRF)/Euro Alliance of Payment Schemes (EAPS). The file format may be any other suitable file format.

In some embodiments, the receiver may be further configured to receive a second data structure. The processor may also be further configured to determine the format of the second data structure. The processor may also be further configured to determine whether the format of the second data structure is a non-exceptional format or an exceptional format. The processor may also be configured to select a second map. The selection may be based on the format of the second data structure. The selection may also be based on the determination whether the format of the second data structure is a non-exceptional format or an exceptional format. The processor may also transform the second data structure into a canonical data structure utilizing the second selected map.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

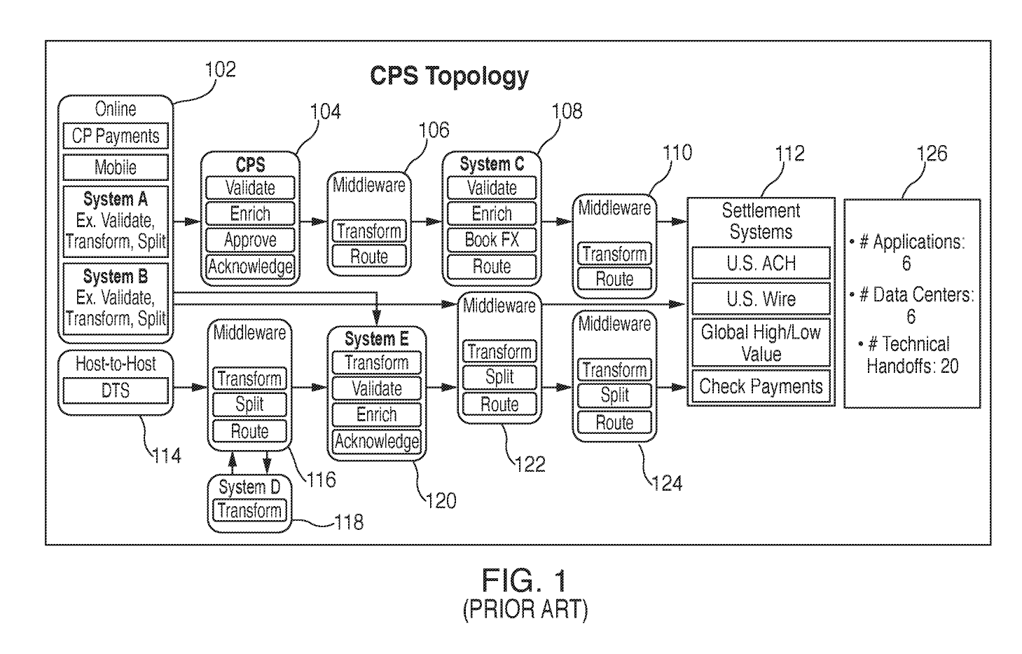

FIG. 1 shows a prior art illustrative architecture diagram. The diagram is entitled CPS (Central Processing System) topology. The diagram indicates the different elements, including applications, data centers and technical handoffs, or transformations, required within a conventional central processing system.

The CPS topology may include online system 102. Online system 102 may receive central processing payments and mobile payments. Online system 102 may also include two payment rules systems, system A and system B. These two systems may validate, transform and/or split the payment structure. The payment structures received at online system 102 may be transmitted to CPS 104, Middleware 122 and/or ECS 120.

CPS 104 may be a payment rules system. CPS 104 may also execute validation, enrichment, approval and/or acknowledgement of the payment structure. The payment structures received at CPS 104 may be transmitted to Middleware 106.

Middleware 106 may also perform transformations and/or routing of the received structures. Middleware 106 may transmit or route the structures to System C 108.

System C 108 may validate or enrich the structures. System C 108 may also book FX trades for the payment structures as well as route the payment structures to different entities. System C 108 may transmit or route payment structures to Middleware 110.

Middleware 110 may transform and/or route the received payment structures. Middleware 110 may transmit the received data structures to settlement systems 112.

Host-to-Host 114 may be an initiation channel. Host-to-Host 114 may include DTS (Data Transformation System). DTS may receive payment structures. Host-to-Host 114 may transmit the payment structures to Middleware 116.

Middleware 116 may transform, split and/or route the received payment structures. Middleware 116 may receive and/or transmit structures to System D 118, which may perform other transformations on the payment structures. Middleware 116 may transmit the received payment structures to System E 120.

System E 120 may transform, validate, enrich and/or acknowledge the received payment structures and/or changes. System E 120 may transmit the payment structures to Middleware 122. Middleware 122 may transform, split, and/or route the payment structures to Middleware 124.

Middleware 124 may transform, split and/or route the payment structures. Middleware 124 may transmit the payment structures to settlement systems 112.

Settlement systems 112 may include U.S. ACH (Automated Clearing House), U.S. Wire, Global High/Low Value, and/or Check Payments. Section 126 shows that the number of applications used in the prior art system is six. Section 126 also shows that the number of data centers used in the prior art system is six. Section 126 also shows that the number of technical handoffs used in the prior art system is twenty.

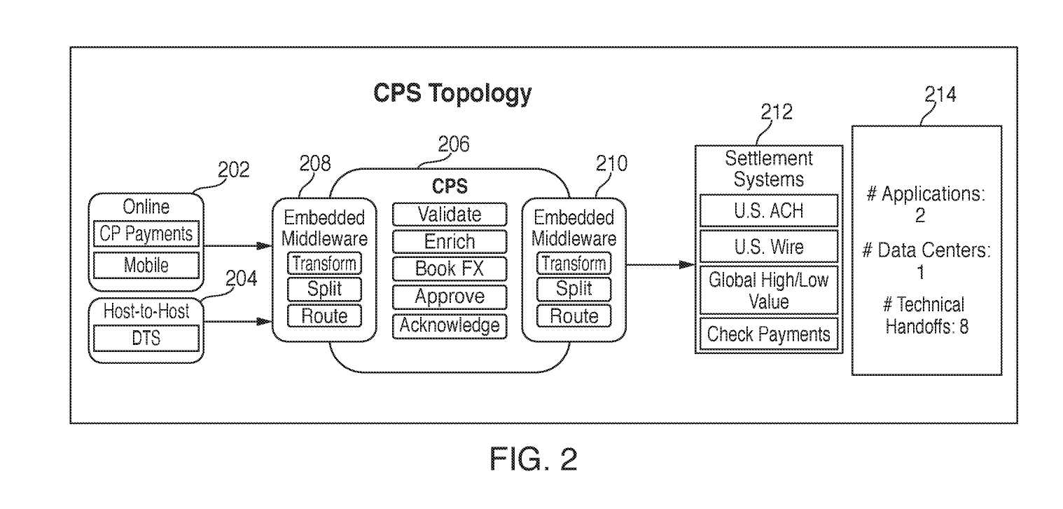

FIG. 2 shows the CPS topology according to certain embodiments. Data structures may be received at online entity 202. Online entity 202 may receive data structures via a CP (central processing) payment system and/or a mobile system. Data structures may also be received at Host-to-Host entity 204. Host-to-Host entity 204 may receive data structures via a DTS system.

Online entity 202 and Host-to-Host entity 204 may transmit the received data structures to CPS 206. The transmission to CPS 206 may be via middleware embedded in CPS 206, as shows at 208. The embedded middleware may transform, split and/or route the data structures.

CPS 206 may validate the data structures, enrich the data structures, book FX trades with the data structures, approve the data structures and/or acknowledge the data structures. Upon completion of the steps outlined above, CPS may transmit the data structures to settlements systems 212, via middleware embedded in CPS 206, as shown at 210.

The data structures may be settled at settlement system 212. Settlement systems 212 may include U.S. ACH (Automated Clearing House), U.S. Wire, Global High/Low Value and Check Payments.

Section 214 shows the utilization of two applications by the CPS topology according to the embodiment shown. Section 214 also shows the utilization of one data center by the CPS topology according to the embodiment shown. Section 214 also shows the utilization of eight technical handoffs by the CPS topology according to the embodiment shown.

The current embodiment includes fewer applications, fewer data centers and fewer technical handoffs as compared to the prior art CPS topology shown in FIG. 1. Therefore, the current embodiment reduces the processing power necessary to operate the CPS topology.

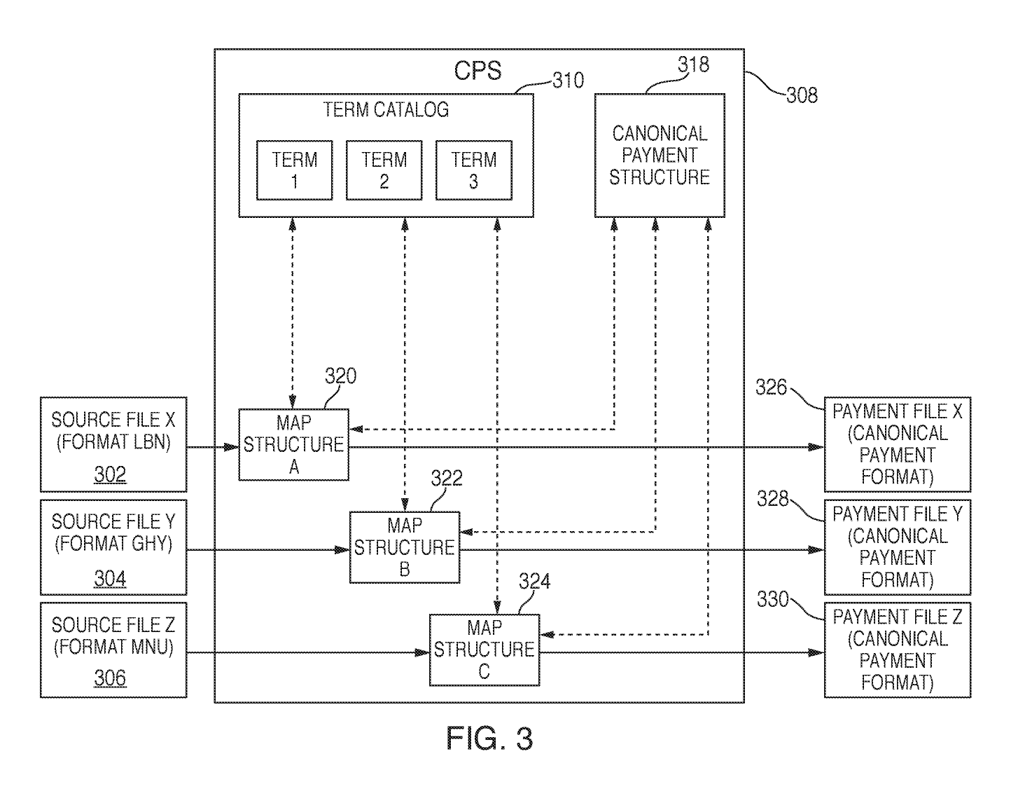

FIG. 3 shows CPS 308. Source file X may be formatted in format LBN, as shown at 302. Source file Y may be formatted in format GHY, as shown at 304. Source file Z may be formatted in format MNU, as shown at 306.

CPS 308 may receive source file X. CPS 308 may determine the format of source file X to be formatted as an LBN. CPS 308 may choose map structure A to transform source file X, as shown at 320. Map structure A may utilize term catalog 310. Term catalog 310 may include term 1, term 2 and term 3. Map structure A may determine where term 1, term 2 and term 3 appear in source file X. Map structure A may retrieve data corresponding to term 1, term 2 and term 3 from source file X. Map structure A may utilize canonical payment structure 318 and the retrieved data to create payment file X in a canonical payment format, as shown at 326.

CPS 308 may receive source file Y. CPS 308 may determine the format of source file Y to be formatted as a GHY. CPS 308 may choose map structure B to transform source file Y, as shown at 322. Map structure B may utilize term catalog 310. Term catalog 310 may include term 1, term 2 and term 3. Map structure B may determine where term 1, term 2 and term 3 appear in source file Y. Map structure B may retrieve data corresponding to term 1, term 2 and term 3 from source file Y. Map structure B may utilize canonical payment structure 318 and the retrieved data to create payment file Y in a canonical payment format, as shown at 328.

CPS 308 may receive source file Z. CPS 308 may determine the format of source file Z to be formatted as an MNU. CPS 308 may choose map structure C to transform source file Z, as shown at 324. Map structure C may utilize term catalog 310. Term catalog 310 may include term 1, term 2 and term 3. Map structure C may determine where term 1, term 2 and term 3 appear in source file Z. Map structure C may retrieve data corresponding to term 1, term 2 and term 3 from source file Z. Map structure C may utilize canonical payment structure 318 and the retrieved data to create payment file Z in a canonical payment format, as shown at 330.

FIG. 4 shows source file X formatted in format LBN, as shown at 402. Source file X may be received at CPS 404. CPS 404 may determine that source file X is formatted in an exceptional format. Therefore, CPS 404 may utilize normalized map structure A, as shown at 412, to transform source file X into payment file X, as shown at 418. Normalized map structure A may include map structure B overlaid on map structure C. Map structure C may be a base map. Map structure B may utilize a term catalog, as shown at 406. Map structure B may also canonical payment structure information, as shown at 408. Map structure B may include portions of map structure C that do not work for format LBN. Map structure B may utilize source file X information to determine which elements of map structure C require change in order to conform map structure B to format LBN.

In some embodiments, CPS 404 may determine source file X information from the receipt of one or more source file X, or format LBN information. In these embodiments, the source file X, or format LBN information may not be stored in CPS 404 until the receipt of at least one source file X or format LBN file.

Map structure B may replace the elements in map structure C that do not conform to source file X. Map structure A may include map structure C with an overlay of map structure B. This may create a normalized map structure A which can be utilized to transform source file X in format LBN into payment file X in a canonical payment format, as shown at 418.

FIG. 5 shows a similar embodiment as shown in FIG. 4. In FIG. 5, normalized map structure A may include map structure C, as shown at 504, incorporated into map structure B, as shown at 506. In this embodiment, map structure C may fit into a specific location within map structure B.

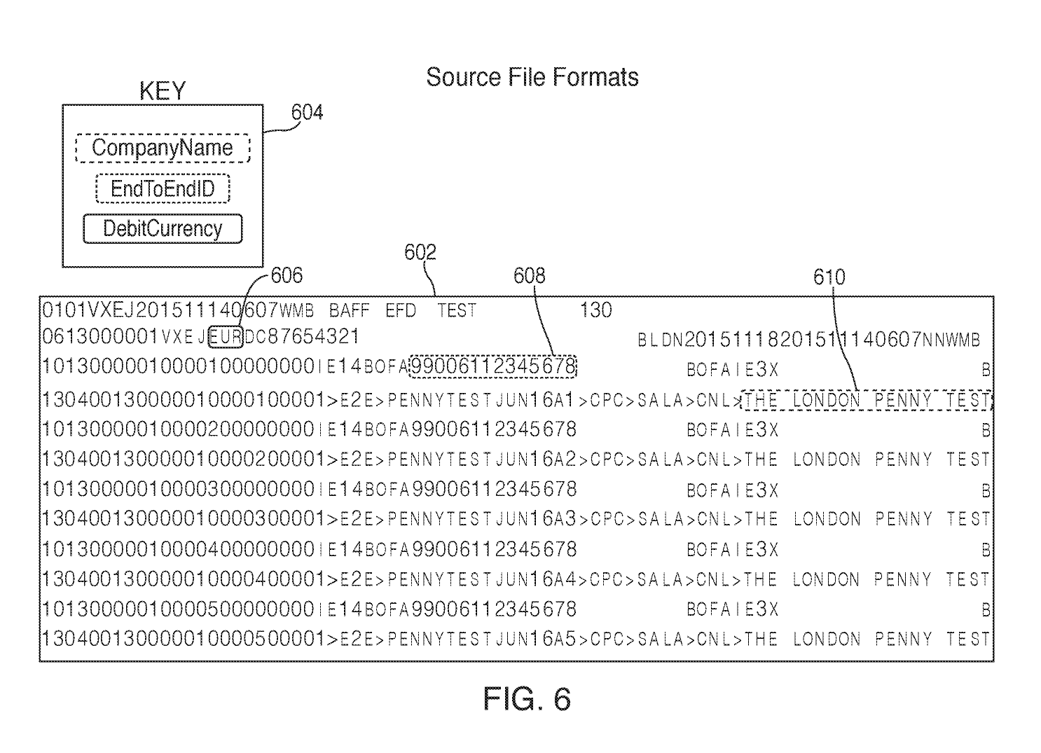

FIG. 6 shows an example of a source file format. Source file 602 may include many different segments of data. In the exemplary embodiment, there may be three segments of data that may be required to create a canonical payment structure. The three data segments may be delineated in key 604. Key 604 may include company name, end to end id and debit currency. It should be appreciated that, in other embodiments, more or less, various data segments may be utilized.

Data segment 606, included in source file 602 may be a debit currency, as delineated by key 604. Data segment 608, included in source file 602, may be an end to end identification (id), as delineated by key 604. Data segment 610, included in source file 602, may be a company name, as delineated by key 604.

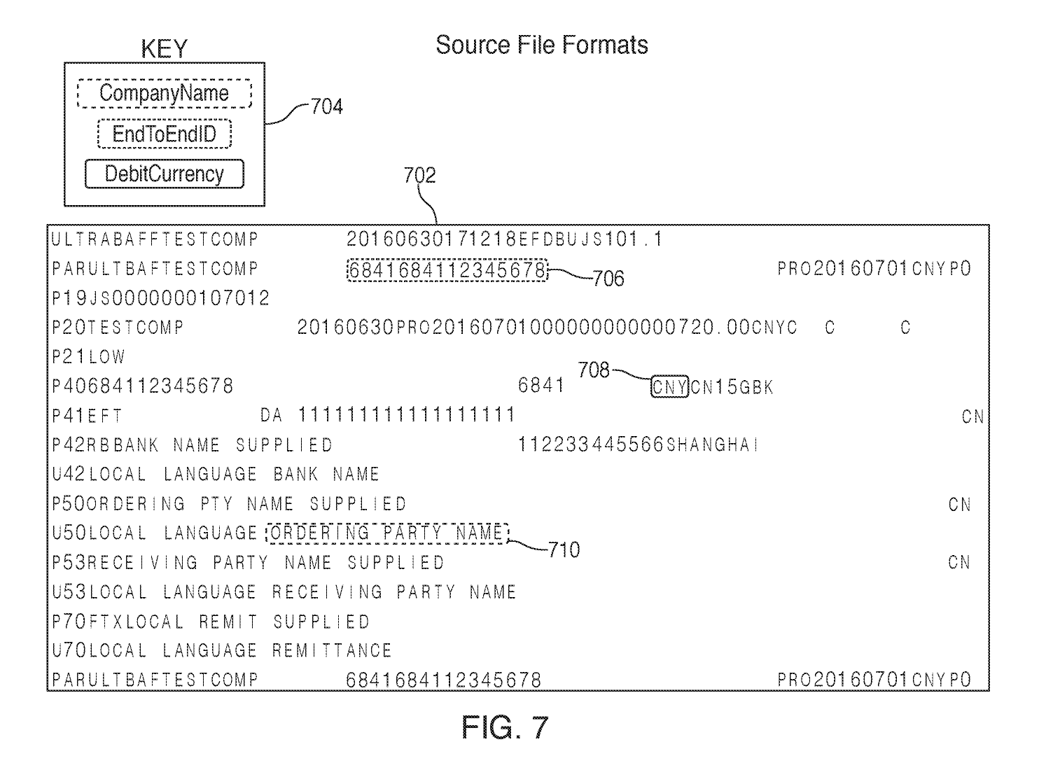

FIG. 7 shows another source file format. Source file format 702 may include many different segments of data. In the exemplary embodiment, there may be three segments of data that may be required to create a canonical payment structure. The three data segments may be delineated in key 704.

Key 704 may include company name, end to end id and debit currency. It should be appreciated that, in other embodiments, more or less data segments may be utilized.

Data segment 706, included in source file 702 may be an end to end id, as delineated by key 704. Data segment 708, included in source file 702, may be a debit currency, as delineated by key 704. Data segment 710, included in source file 702, may be a company name, as delineated by key 704.

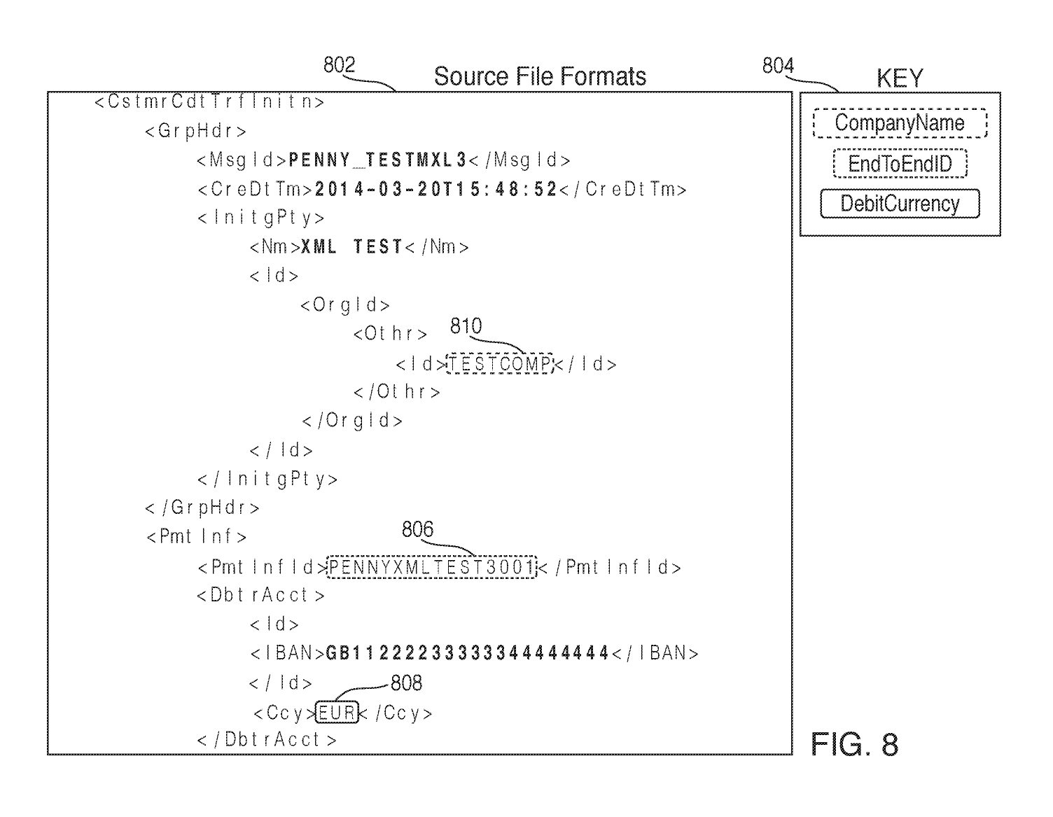

FIG. 8 shows another source file format. Source file format 802 may include many different segments of data. In the exemplary embodiment, there may be three segments of data that may be required to create a canonical payment structure. The three data segments may be delineated in key 804.

Key 804 may include company name, end to end id and debit currency. It should be appreciated that, in other embodiments, more or less, various data segments may be utilized.

Data segment 806, included in source file 802 may be an end to end id, as delineated by key 804. Data segment 808, included in source file 802, may be a debit currency, as delineated by key 804. Data segment 810, included in source file 802, may be a company name, as delineated by key 804.

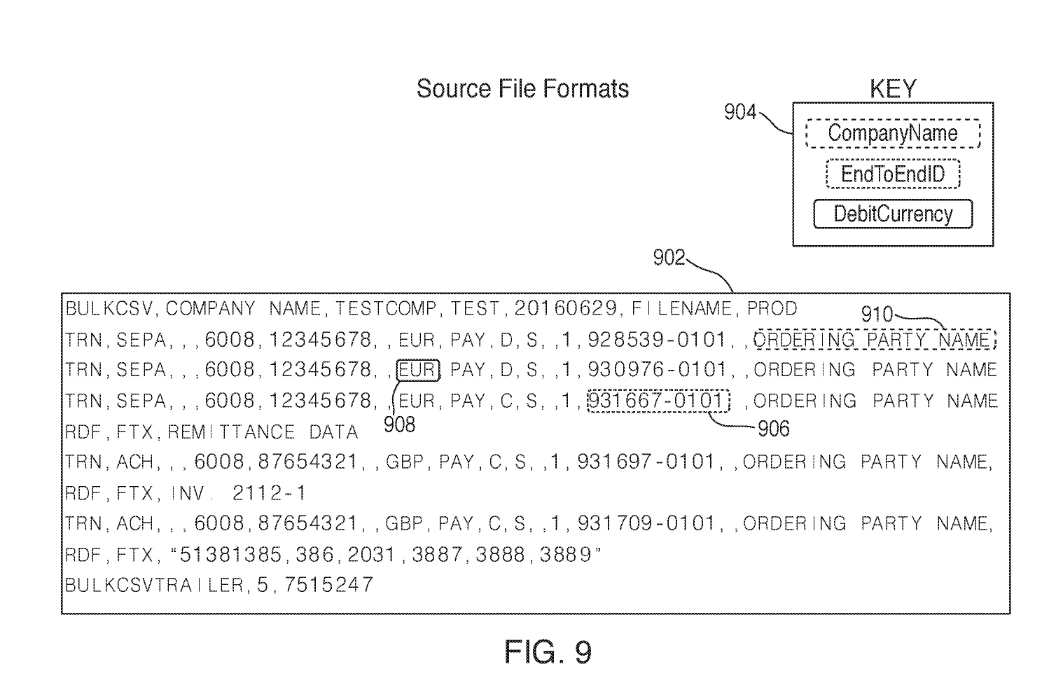

FIG. 9 shows another source file format. Source file format 902 may include many different segments of data. In the exemplary embodiment, there may be three segments of data that may be required to create a canonical payment structure. The three data segments may be delineated in key 904.

Key 904 may include company name, end to end id and debit currency. It should be appreciated that, in other embodiments, more or less, various data segments may be utilized.

Data segment 906, included in source file 902 may be an end to end id, as delineated by key 904. Data segment 908, included in source file 902, may be a debit currency, as delineated by key 904. Data segment 910, included in source file 902, may be a company name, as delineated by key 904.

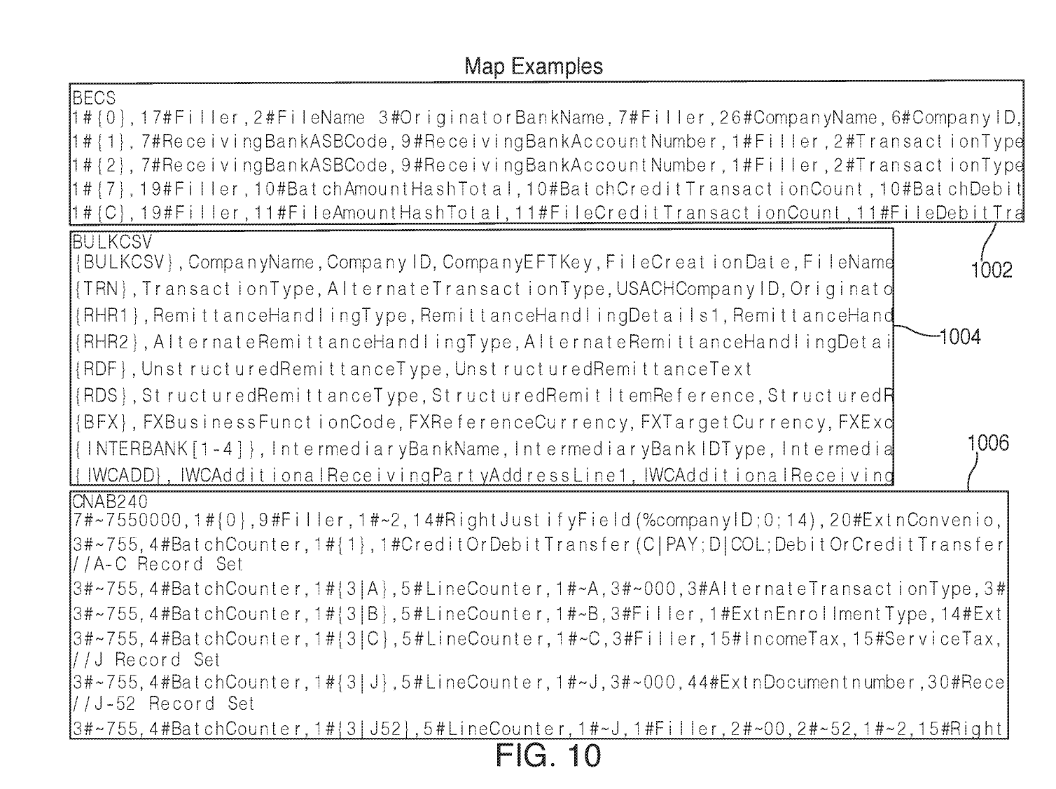

FIG. 10 shows three exemplary maps. Map 1002 may be for a BECS format. Map 1002 may include instruction where to retrieve the information from a BECS data structure. In the first line of the BECS map, the map shows the first space may be utilized for a specific segment of information. The map shows that the next 17 spaces may be a filler, or unnecessary to create a canonical data structure. The map shows that the next 2 spaces may be a file name. The map shows that the following 3 spaces may include a name of the originator bank. Map 1002 shows more data and information in the remaining portions of the map.

Map 1004 may be for a BULKCSV file. A BULKCSV file may be a specific type of CSV, or comma separated value file. In such a file, the information segments may be separated by commas. May 1004 may show that, on the first line, designated by the term BULKCSV in curly brackets, a company name is found after the first comma, a company id is found after the second comma and a company EFT key is found after the third comma. Map 1004 shows more data and information in the remaining portions of the map.

Map 1006 may be for a CNAB240 file. A CNAB240 file may be a payment file format. Map 1006 shows that the first 7 spaces may include a number— 7550000. Map 1006 also shows that the next 1 space may include a specific segment of information. Map 1006 also shows that the next 9 spaces may be filler, or not contain any useful information. Map 1006 also shows that the next 1 space may include a specific segment of information. Map 1006 also shows that the next 14 spaces may include a company name when the elements of the 14 spaces are right justified modulus from spaces zero through fourteen. Map 1006 shows more data and information in the remaining portions of the map.

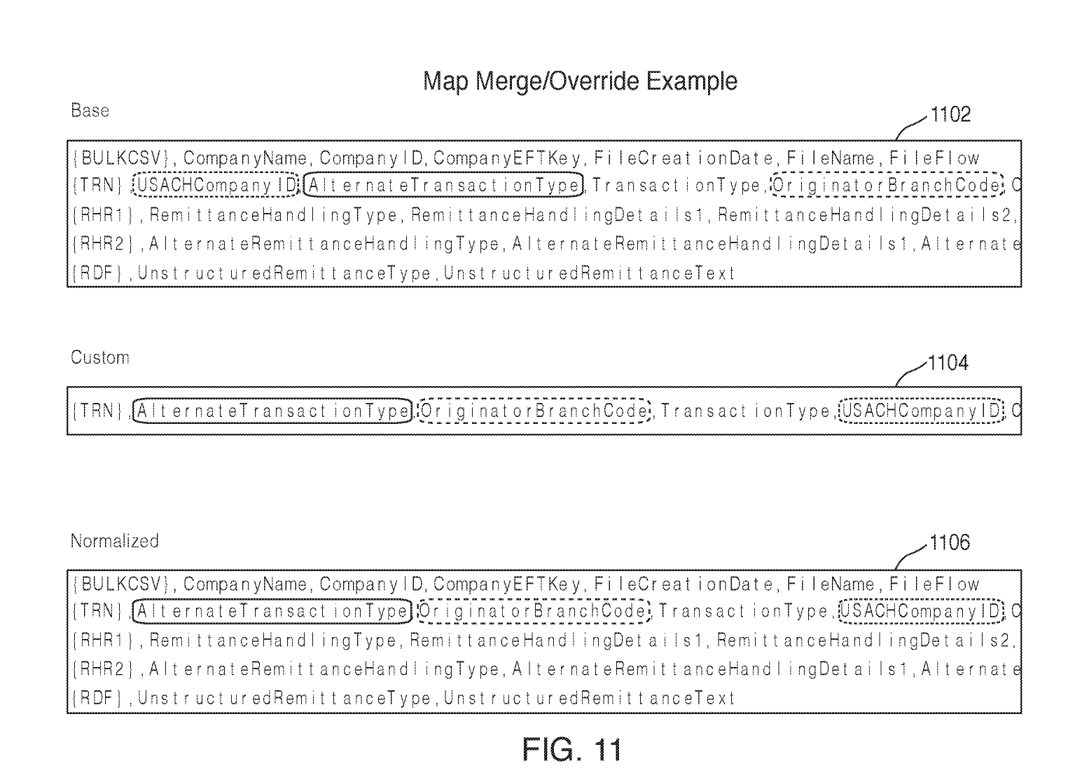

FIG. 11 shows a map merge or override example. Base map 1102 may include line TRN (Transaction). Line TRN may include end to end id following the first comma, debit currency following the second comma and company name following the fourth comma. In one exceptional data structure following the map 1102, the TRN line may be different. Therefore, custom map 1104 may include only the TRN line. Custom map 1104 may include a debit currency after the first comma, a company name after the second comma and an end to end id after the fourth comma.

Normalized map may 1106 may include the information included in base map 1102 with custom map 1104 overlain on top. This may enable processing of exceptional data structures.

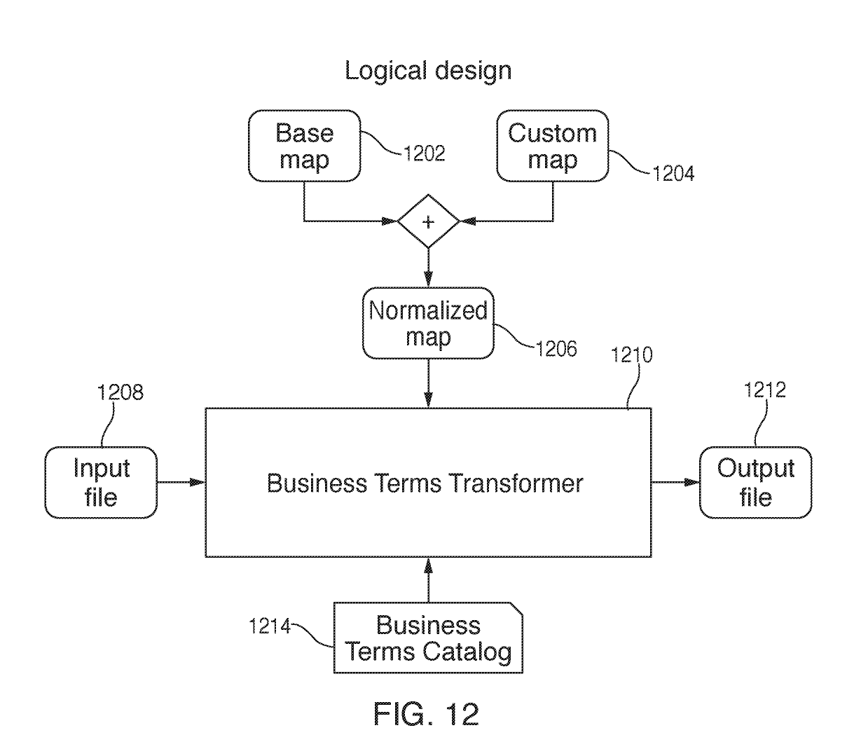

FIG. 12 shows a flow chart. Base map 1202 may be combined with custom map 1204. The combination may create normalized map 1206. The normalized map may be incorporated into business terms transformer 1210. Business terms transformer 1210 may utilize business terms catalog 1214 in addition to the normalized map. Input file 1208 may be inputted into business terms transformer 1210 to create output file 1212.

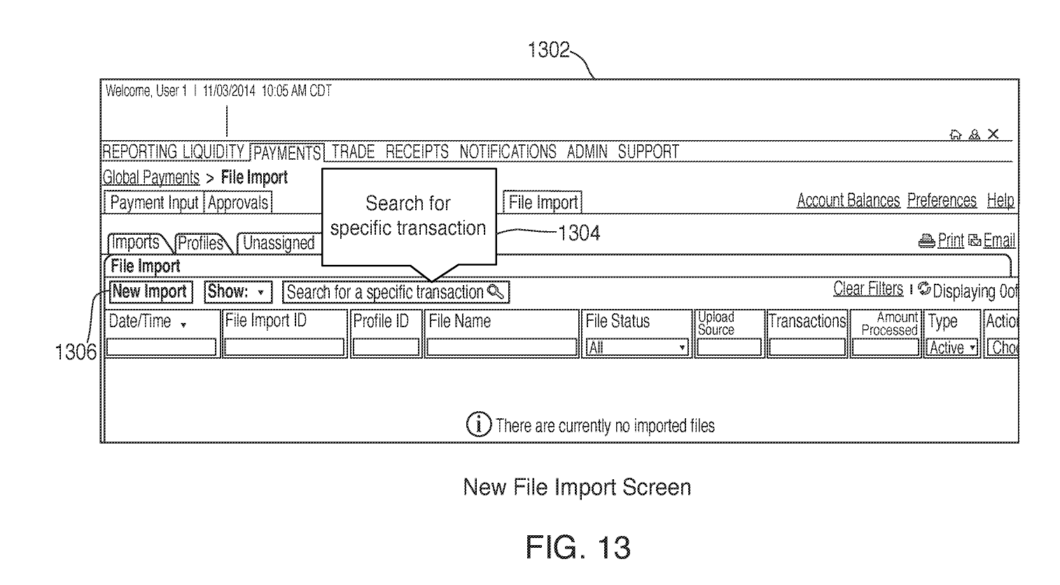

FIG. 13 shows GUI 1302. GUI 1302 may enable a user to import a group of transactions. Once the group of transaction is uploaded, a user may search for a specific transaction, as shown at 1304. A user may select 1306 in order to upload a group of transaction or a single transaction.

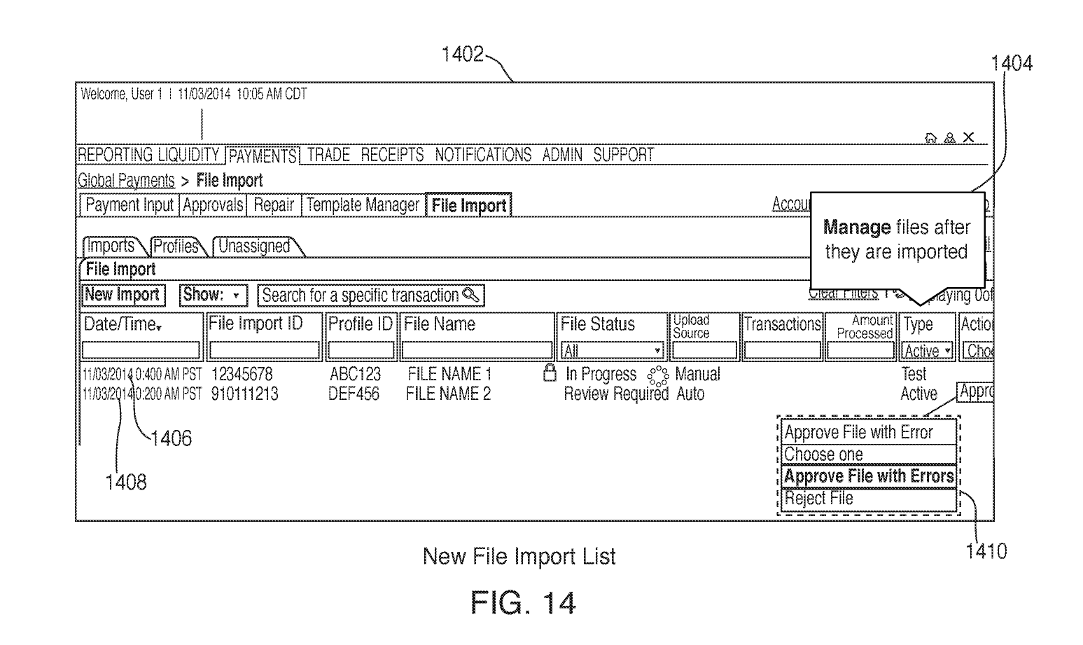

FIG. 14 shows GUI 1402. GUI 1402 may show a list of transaction once the transactions were imported. A user may manage the transactions after the transaction are imported, as shown at 1404. Transactions 1406 and 1408 have both been uploaded. Transaction 1406 may be in progress. Transaction 1408 may require review. This may be because transaction 1408 may have an error. The system may know about the error because the system mapped the transaction utilizing the maps discussed above into a canonical data map. Therefore, the system may be able to inform the user that there is an error prior to submission of the transaction. A user may approve the file with errors or reject the file, as shown at 1410.

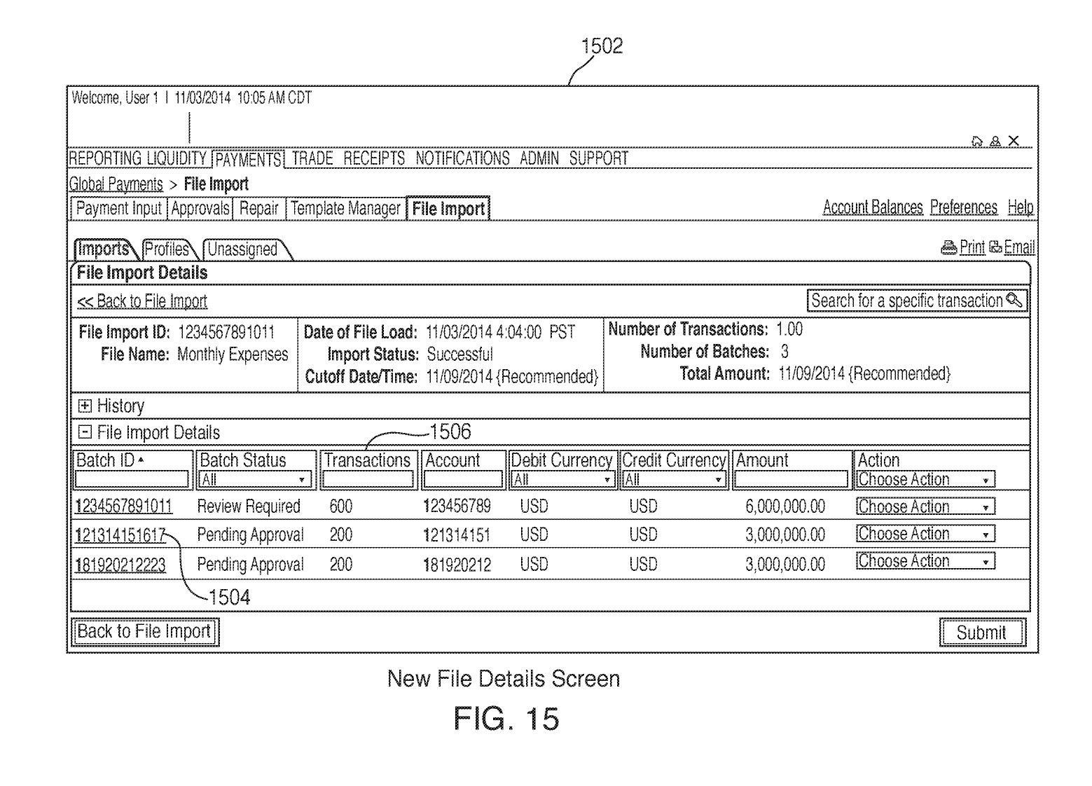

FIG. 15 shows GUI 1502. GUI 1502 shows a list of batches of transactions, as shown at 1504. Each batch of transactions may include hundreds of individual transactions, as shown at 1506.

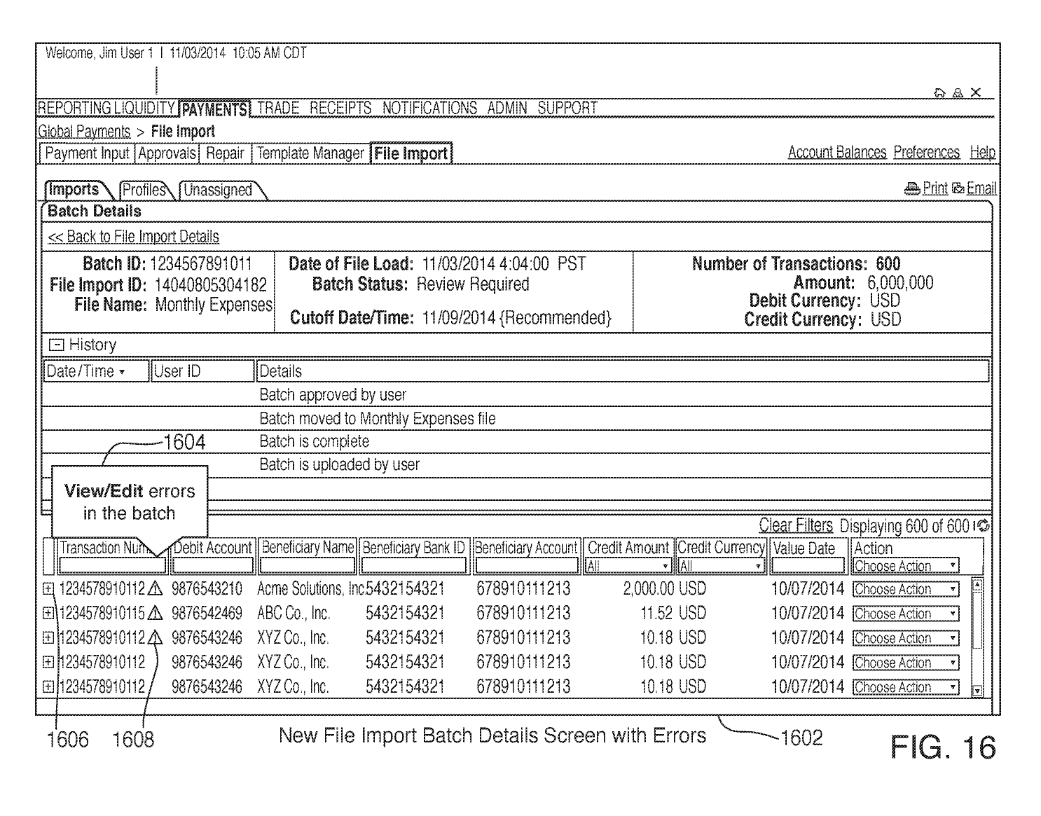

FIG. 16 shows GUI 1602. GUI 1602 enables a user to view or edit errors within the specific transaction of the batch of transactions, as shown at 1604. The GUI may also show a user which transaction, includes errors, as shown with symbol 1608.

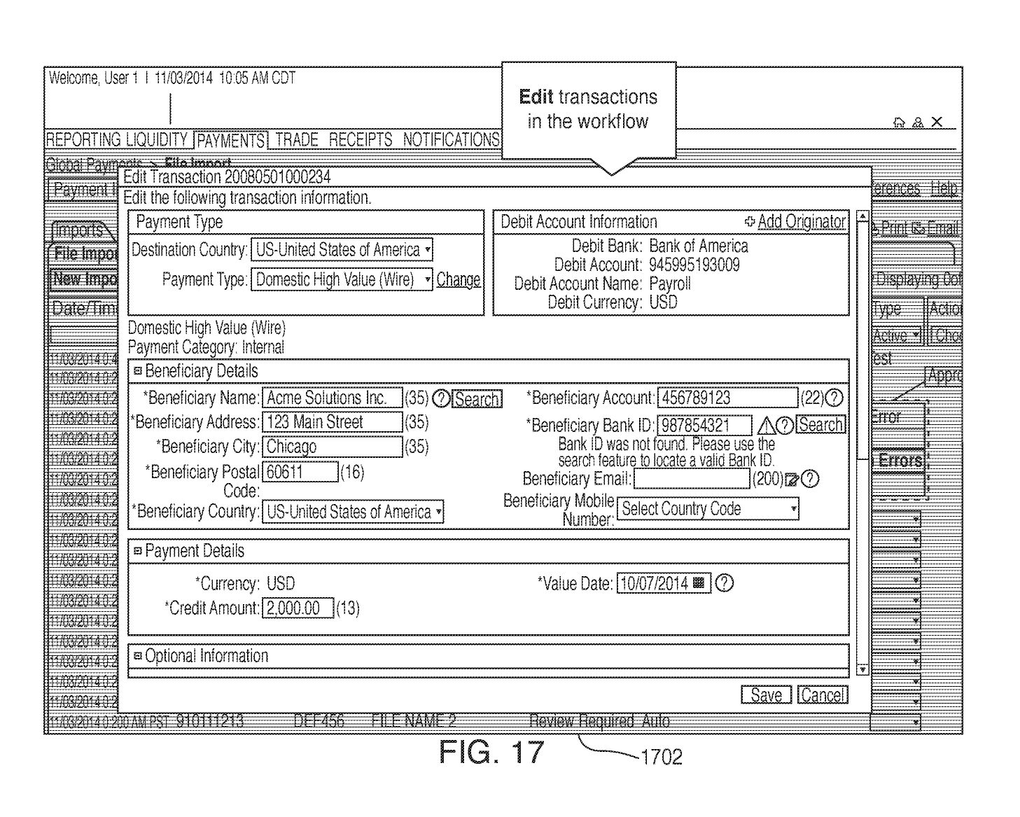

FIG. 17 shows GUI 1702. GUI 1702 enables a user to edit a specific transaction within the workflow. In the event that a user views an error, a user may open the transaction to edit the transaction. The system may enable to user to change payment type information, debit account information, beneficiary details, payment details and other information. The system may inform the user that the changes that he or she made removed the errors from the transaction.

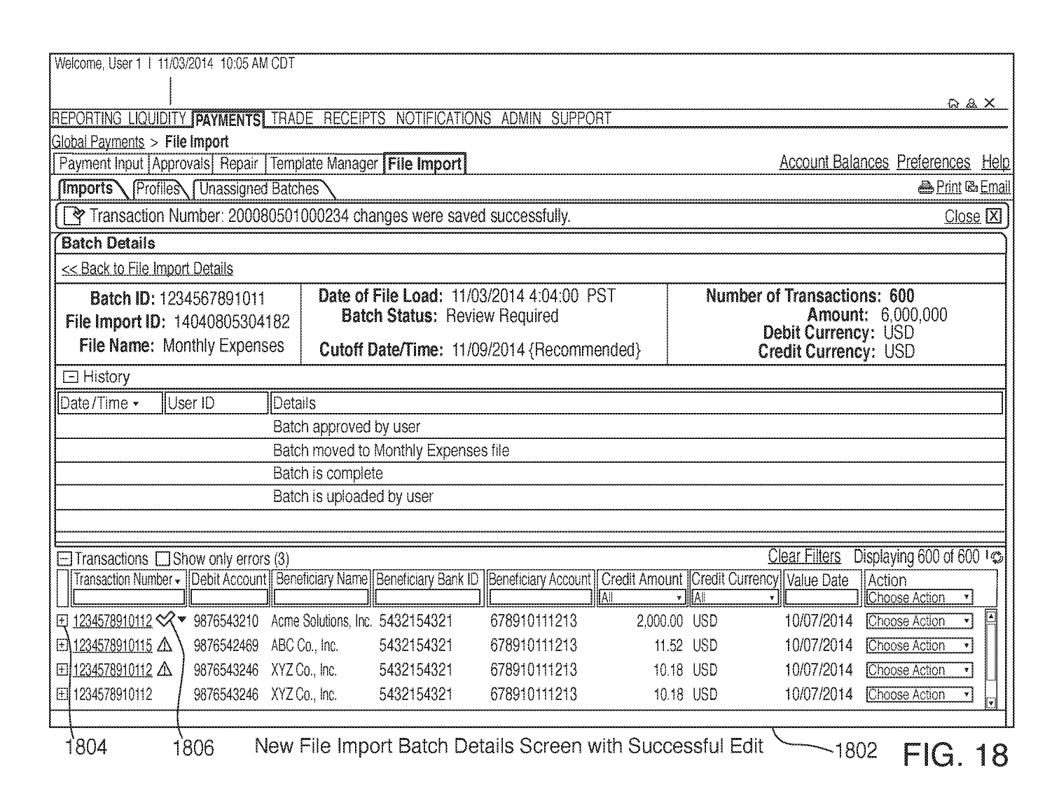

FIG. 18 shows GUI 1802. GUI 1802 may include transaction 1804. Transaction 1804 may have been repaired by a user using a GUI similar to GUI 1702 shown above. The transaction may have included an error prior to the repair of the transaction. Following the repair, symbol 1806 shows that the transaction has been repaired.

Thus, methods and apparatus for canonical data structure mapping are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for transforming a data structure in a specific format into a data structure in a canonical format, the method comprising:
receiving a plurality of specific data structure formats, wherein each data structure format designates a plurality of component parts in a predetermined order;
defining a base map for each specific data structure format, said base map defining a plurality of specific locations for retrieving a predetermined set of data;
receiving a plurality of exceptional data structure formats, wherein each of the plurality of exceptional formats is associated with a specific data structure format, each exceptional format designating a partially different order of component parts from the designated order of component parts of the specific format with which the exceptional format is an exception thereto;
defining at least one custom map for each exceptional format, the custom map only including a portion of the base map, said portion of the base map being associated with the component parts which are in the partially different order;
overlaying the at least one custom map on the associated base map to create a normalized map for each exceptional format;
receiving a data structure;
determining the format of the data structure;
determining whether the format of the data structure is a non-exceptional format or an exceptional format;
selecting a map based on:
the format of the received data structure; and
the determining whether the format is a non-exceptional format or an exceptional format; and
transforming the received data structure into a canonical data structure utilizing the selected map.

2. The method of claim 1, wherein the transforming comprises:
retrieving a predetermined number of data segments from locations determined by the selected map; and
placing the data segments into the canonical data structure based on a canonical terms catalog.

3. The method of claim 1, wherein the received data structure is a payment data structure.

4. The method of claim 1, wherein a file format of the received data structure is:
eXtensible Markup Language (XML);
delimited;
positional;
Society for Worldwide Interbank Financial Telecommunications (SWIFT);
International Organization for Standardization (ISO);
National Automated Clearing House Association (NACHA);
Accredited Standards Committee X12;
Electronic Data Interchange X12; or
Computer Readable Format (CRF)/Euro Alliance of Payment Schemes (EAPS).

5. The method of claim 1, wherein the method further comprises:
receiving a second data structure;
determining the format of the second data structure;
determining whether the format of the second data structure is a non-exceptional format or an exceptional format;
selecting a second map based on:
the format of the second data structure; and
the determining whether the format of the second data structure is a non-exceptional format or an exceptional format; and
transforming the second data structure into a second canonical data structure utilizing the second selected map.

6. The method of claim 1, further comprising iterating through the method set forth in claim 1 with a second data structure.

7. An apparatus for transforming a data structure in a specific format into a data structure in a canonical format, the apparatus comprising:
a receiver configured to receive:
a plurality of specific data structure formats, wherein each specific data structure format designates a plurality of component parts in a predetermined order;
a plurality of exceptional data structure formats, wherein each of the plurality of exceptional formats is associated with a specific data structure format, each exceptional format designating a partially different order of component parts from the order of component parts of the specific format with which the exceptional format is an exception thereto;
a processor configured to:
define a base map for each specific data structure format, said base map defining a plurality of specific locations for retrieving a predetermined set of data;
define at least one custom map for each exceptional format, the custom map including a portion of the base map, said portion of the base map being associated with the component parts which are in the partially different order;
overlay the at least one custom map on the associated base map to create a normalized map for each exceptional format;
the receiver further configured to receive:
a data structure;
the processor further configured to:
determine the format of the data structure;
determine whether the format of the data structure is a non-exceptional format or an exceptional format;
select a map based on:
the format of the received data structure; and
the determination whether the format is a non-exceptional format or an exceptional format; and
transform the received data structure into a canonical data structure utilizing the selected map.

8. The apparatus of claim 7, wherein the transformation comprises:
retrieving a predetermined number of data segments from locations determined by the selected map; and
placing the data segments into the canonical data structure based on a canonical terms catalog.

9. The apparatus of claim 7, wherein the received data structure is a payment data structure.

10. The apparatus of claim 7, wherein a file format of the received data structure is:
eXtensible Markup Language (XML);
delimited;
positional;
Society for Worldwide Interbank Financial Telecommunications (SWIFT);
International Organization for Standardization (ISO);
National Automated Clearing House Association (NACHA);
Accredited Standards Committee x12;
Electronic Data Interchange x12; or
Computer Readable Format (CRF)/Euro Alliance of Payment Schemes (EAPS).

11. The apparatus of claim 7, wherein:
the receiver is further configured to receive:
a second data structure;
the processor is further configured to:
determine the format of the second data structure;
determine whether the format of the second data structure is a non-exceptional format or an exceptional format;
select a second map based on:
the format of the second data structure; and
the determination whether the format of the second data structure is a non-exceptional format or an exceptional format;
transform the second data structure into a canonical data structure utilizing the second selected map.

12. A method for transforming a payment structure in a specific format into a payment structure in a canonical format, the method comprising:
receiving a plurality of specific payment structure formats, wherein each payment structure format designates a plurality of component parts in a predetermined order;
defining a base map for each specific payment structure format, said base map defining a plurality of specific locations for retrieving a predetermined set of data;
receiving a plurality of exceptional payment structure formats, wherein each of the plurality of exceptional formats is associated with a specific payment structure format, each exceptional format designating a partially different order of component parts from the designated order of component parts of the specific format with which the exceptional format is an exception thereto;
defining at least one custom map for each exceptional format, the custom map only including a portion of the base map, said portion of the base map being associated with the component parts which are in the partially different order;
overlaying the at least one custom map on the associated base map to create a normalized map for each exceptional format;
receiving a payment structure;
determining the format of the payment structure;
determining whether the format of the payment structure is a non-exceptional format or an exceptional format;
selecting a map based on:
the format of the received payment structure; and
the determining whether the format is a non-exceptional format or an exceptional format; and
transforming the received payment structure into a canonical payment structure utilizing the selected map.

13. The method of claim 12, wherein the transforming comprises:
retrieving a predetermined number of data segments from locations determined by the selected map; and
placing the data segments into the canonical payment structure based on a canonical terms catalog.

14. The method of claim 12, wherein a file format of the received payment structure is:
eXtensible Markup Language (XML);
delimited;
positional;
Society for Worldwide Interbank Financial Telecommunications (SWIFT);
International Organization for Standardization (ISO);
National Automated Clearing House Association (NACHA);
Accredited Standards Committee X12;
Electronic Data Interchange X12; or
Computer Readable Format (CRF)/Euro Alliance of Payment Schemes (EAPS).

15. The method of claim 12, wherein the method further comprises:
receiving a second payment structure;
determining the format of the second payment structure;
determining whether the format of the second payment structure is a non-exceptional format or an exceptional format;
selecting a second map based on:
the format of the second payment structure; and
the determining whether the format of the second payment structure is a non-exceptional format or an exceptional format; and
transforming the second payment structure into a second canonical payment structure utilizing the second selected map.

16. The method of claim 12, further comprising iterating through the method set forth in claim 1 with a second payment structure.
